(19) United States
(12) Patent Application Publication
(10) Pub. No.: US 2009/0012799 A1
(43) Pub. Date: Jan. 8, 2009

(54) COMMUNITY-BASED TRAVEL DESTINATION DETERMINATION

(75) Inventors: Jim Hornthal, San Francisco, CA (US); Sharlene Wang, Sunnyvale, CA (US)

Correspondence Address: Trellis Intellectual Property Law Group, PC, 1900 EMBARCADERO ROAD, SUITE 109, PALO ALTO, CA, 94303, US

(73) Assignee: HORNTHAL INVESTMENT PARTNERS, LP, San Francisco, CA (US)

(21) Appl. No.: 11/773,374

(22) Filed: Jul. 3, 2007

(51) Int. Cl. G06Q 50/00

(52) U.S. Cl. 705/1; 701/211

(57) ABSTRACT

In one embodiment, a method for providing destination matching results for a community of users is provided. For example, a community of users may want to plan a trip together. Each of the users can create a travel profile of attributes. Once the travel profiles are received from the community of users, destination matching results based on the travel profiles of the users taken in combination are determined based on the destination profiles for destinations. For example, the ten best destinations that are determined to best match the travel profiles of the community of users are selected. The search result of destinations is then provided for access by the community of users. For example, a web page may be created that includes the search results. Each of the community of users may access the web page and review the results.

### BACKGROUND

Particular embodiments generally relate a matching engine for travel destinations.

The worldwide web (WWW) includes a wealth of information. Users may go to many different websites to learn about various destinations when planning a trip, such as a vacation. Also, users can search for airfare, hotels, and other things that need to be purchased. Sometimes, the amount of information on the web is intimidating and a user cannot possibly find all relevant and useful information efficiently in a short amount of time. Thus, a user may only look at a subset of the available information.

Also, when planning a trip with multiple people, the process of determining where to go may be a hard decision to make. Often, people may have conflicting ideas on where they want to go. To resolve the conflicts, people may perform individual research and then hold informal conversations or send emails amongst one another with their findings. This process may go back and forth, and is inefficient. Further, determining where to go is complicated by the wealth of information scattered on the worldwide web.

### SUMMARY

In one embodiment, a method for providing destination matching results for a community of users is provided. For example, a community of users may want to plan a trip together. Any single user, (the initiator), may create a “merged profile” and invite a community of users to link their individual travel profiles to a shared community travel profile (merged profile). Each of the participating users can create an individual travel profile of attributes and link that individual travel profile to the merged profile. The individual travel profile may include rankings and/or ratings for selected attributes. The attributes may be characteristics attributable to a destination or characteristics a user may be interested in, such as activities and interests.

Also, an administrator may provide ratings for destinations. The administrator may be an expert in the field or have knowledge about the field. For example, a travel expert may have extensive knowledge of a location because they have traveled there frequently, studied the history of the destination, etc. The ratings may include the attributes that may be associated with the destination. For example, an administrator (e.g., a travel expert) may input that a destination may be known for scuba diving and tourist activities but may not be known for its food. A destination profile for each possible destination is then generated from the administrative input.

Once the travel profiles are received from the community of linked users, the merged travel profile, incorporating all the individual travel profiles from the community of users, is generated. Destination matching results based on the travel profiles of the users taken in combination (the merged profile) are determined based on the destination profiles for destinations. For example, the fifty best destinations that are determined to best match the weighted priorities of the merged profile are selected. The ratings submitted by the experts for destinations are used to determine destinations that best match the merged profile. The search result of destinations is then provided for access by the community of users. For example, a web page may be created that includes the search results. Each member of the community of users may access the web page and review the results.

In one embodiment, a list or map of destinations may be provided to the community of users. The coordination of receiving the travel profiles, creating the merged profile and generating the destination matching results for the users is provided by the matching engine. Also, if any of the users in the community wants to change their travel profile after seeing the results, they may do so and different results may be generated and saved. Then, each of the community of users may be notified that the destination matching results have changed and each may subsequently view the new version of the saved destination matching results.

Thus, particular embodiments allow a community of users to plan a trip together. The matching engine provides coordination among the users to generate a list of possible destinations. This is very useful when trying to determine where to go for a trip. Instead of having offline discussions individually, users may provide their travel profile and be provided with a list of destinations that best matches their individual and shared attributes.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows an example of a system for providing destination matching results according to one embodiment.

FIG. 2 depicts a simplified flowchart of a method for generating user profiles according to one embodiment.

FIGS. 3A and 3B show an example of a page that includes a list of attributes.

FIG. 4 shows an example of a page that may be used to rank the selected attributes according to one embodiment.

FIG. 5 depicts an example of a flowchart for inputting ratings to create destination profiles for destinations according to one embodiment.

FIG. 6 shows an example of a rating page according to one embodiment.

FIG. 7 depicts an example of a flowchart for providing destination results.

FIG. 8 depicts an example of a web page that includes a map according to one embodiment.

FIG. 9 shows an example of a list of destinations according to one embodiment.

FIG. 10 shows a page displaying more details for a destination according to one embodiment.

FIG. 11 shows an example of a simplified flowchart for providing new destination matching results.

### DETAILED DESCRIPTION OF EMBODIMENTS

### Overview

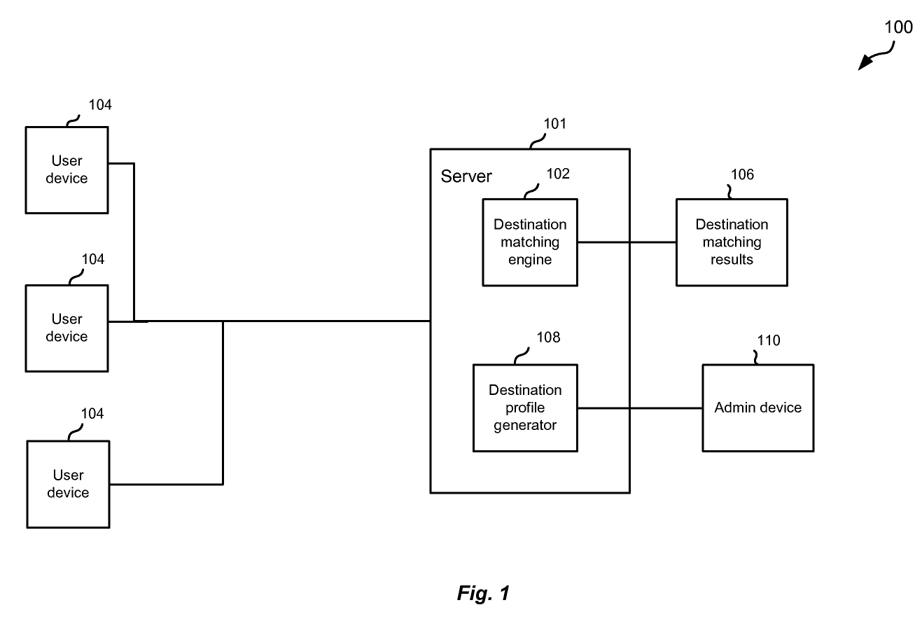

FIG. 1 shows an example of a system 100 for providing destination matching results according to one embodiment. As shown, a destination matching engine 102, plurality of user devices 104, destination matching results 106, a destination profile generator 108, and an administrator device 110 are provided.

Destination matching engine 102 is configured to provide destination matches based on the attributes specified by users. In one embodiment, destination matching engine 102 may be found on a server 101 or any other computing device. In one embodiment, destination matching engine 102 may be an application on a web server that communicates over the Internet.

User devices 104 may be any suitable computing devices that can be used by users. For example, user devices 104 may include personal computers, laptop computers, cellular phones, personal digital assistants (PDAs), portable email devices, smart phones, etc. Various users may use user devices 104 to communicate with destination matching engine 102. Software may be installed on user devices 104 to allow viewing of various pages, such as web pages. In one example, user devices 104 and destination matching engine 102 communicate in a client/server environment that is commonly known as the Internet. The software may include a web browser in which web pages may be served to user devices 104.

A community of users may decide to plan a trip together. It will be understood that a community of users may be multiple users or a single user. A trip may include a destination, which may be any location. For example, a destination may be a geographic location such as a country, city, island, etc. Also, the destination may be other locations, such as museums, tourist activities, etc. Although a trip is described, particular embodiments may be used in other fields, such as financial services, health care, etc. The variations will be discussed in more detail below.

In planning the trip, many items need to be addressed. For example, the users must first decide on a destination where they want to go. This may be a labor-intensive process that may require lots of research into various destinations. Conventionally, this would involve many discussions among the users and then each individual user would do separate research. Users may provide suggestions to the group through disjointed phone calls and e-mails. This may be an inefficient process. In contrast, particular embodiments allow users to provide a travel profile of attributes. The attributes may be any attributable feature for a destination, such as interests and activities. The travel profile of attributes for each of the users is then combined to create a merged profile that reviews and prioritizes the attributes of the entire community of users. This merged profile is used to determine destinations to include in destination matching results 106. This is a list of destinations that best match the attributes of the travel profiles for the community of users. The users can then use this list as a starting point for determining where they want to go.

Destination matching results 106 may be provided in many different forms. For example, a map of the destinations may be provided. The destinations matching the travel profiles may be marked using pins or any other marker. Users may then select a marker and be provided with more information on the destination. A user may also select the destination and be shown a page with even more information on the destination, which will be described in more detail below.

Also, a list of destinations in text form may be provided. Short passages of information on each destination may be included for each destination. The user may then select a destination and be provided with additional information.

Destination profile generator 108 allows an administrator to generate destination profiles for destinations. For example, an administrator, such a travel expert, is used to determine which attributes a destination offers. Further, the administrator may rate how strong the attribute is for the destination. The expert has certain qualifications and/or knowledge about the destinations that help them rate the destination's attributes. For example, a destination may be well-known for its scuba diving and thus receives a high rating for scuba. Administrators may use administrative devices 110 to input the ratings for the attributes.

Destination profile generator 108 then can generate destination profiles for all destinations that may be searched. Destination matching engine 102 uses the destination profiles to determine destination matching results 106 based on a community of users travel profiles. For example, a ranking of attributes by the user is overlayed on the ratings of attributes by experts for destinations. Destination matching engine 102 then determines destinations that best match the rankings of attributes. Thus, users can provide a list of attributes and be presented with destinations that are determined to best provide the attributes.

Accordingly, particular embodiments provide the coordination for multiple users in determining destinations that match the specified attributes. Also, destination matching results 106 are accessible by each user through user devices 104. For example, users may view a web page that includes destination matching results 106. Further, other notification methods may be used, such as destination matching results 106 may be sent in an e-mail to a user's e-mail account. Thus, the process of determining possible destinations for a trip and determining more information on those destinations is simplified using particular embodiments.

The process of determining destination matching results will now be described in more detail. The process includes generating user profiles, generating destination profiles, providing results, and continued coordination after the results are generated.

### Travel Profile Generation

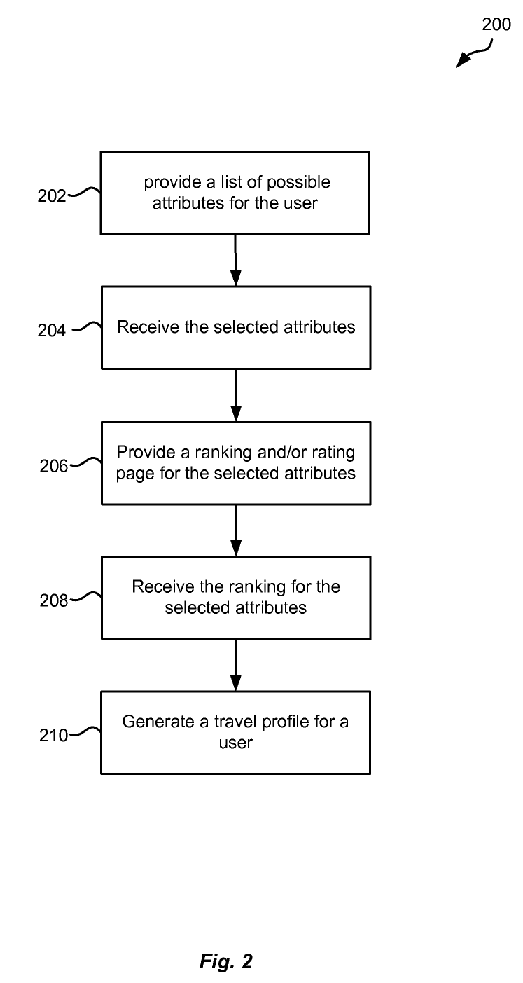

FIG. 2 depicts a simplified flowchart 200 of a method for generating user profiles according to one embodiment. The process described in FIG. 2 may be performed by each user of the community. Accordingly, each user may create a travel profile.

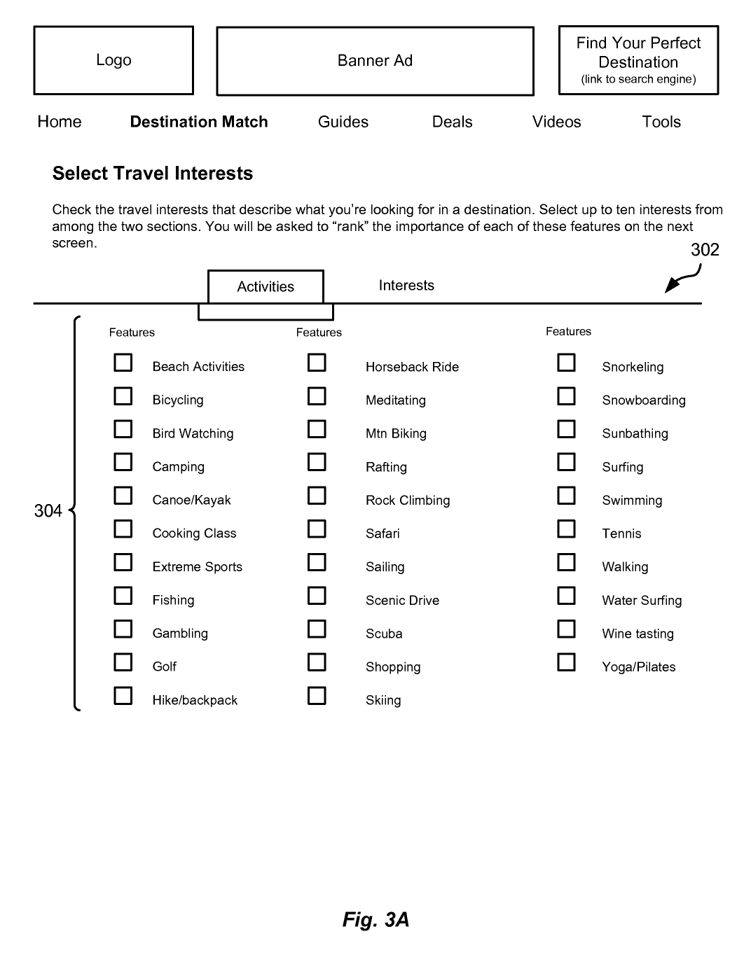

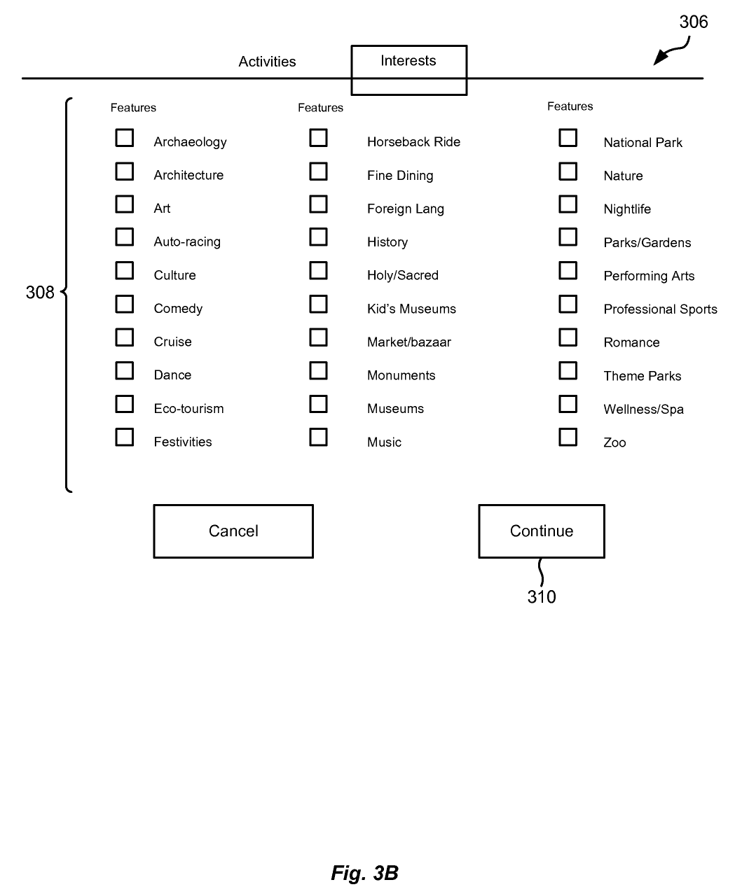

In step 202, destination matching engine 102 provides a list of possible attributes for the user. FIG. 3A shows an example of a page 300 that includes a list of attributes. As shown, the attributes may be referred to as activities 304 and interests 308, and are shown on different tabs 302.

In page 300, various activities 304 are provided. A user may check the activities that the user may be interested in. For example, if a user wants to have scuba and surfing as a possibility in the trip, then those activities can be checked. Various interests 308, as seen in FIG. 3B, are shown on page 300. The user can select categories. For example, if the user is interested in fine dining and nightlife, those categories may be selected or checked.

In step 204, destination matching engine 102 receives the selected attributes. For example, the user may submit the attributes using user device 104 by selecting a continue button 310 on page 300. Destination matching engine 102 may then receive the selected attributes from user device 104.

In step 206, destination matching engine 102 provides a ranking and/or rating page for the selected attributes. This allows a user to input the desirability for each of the selected attributes.

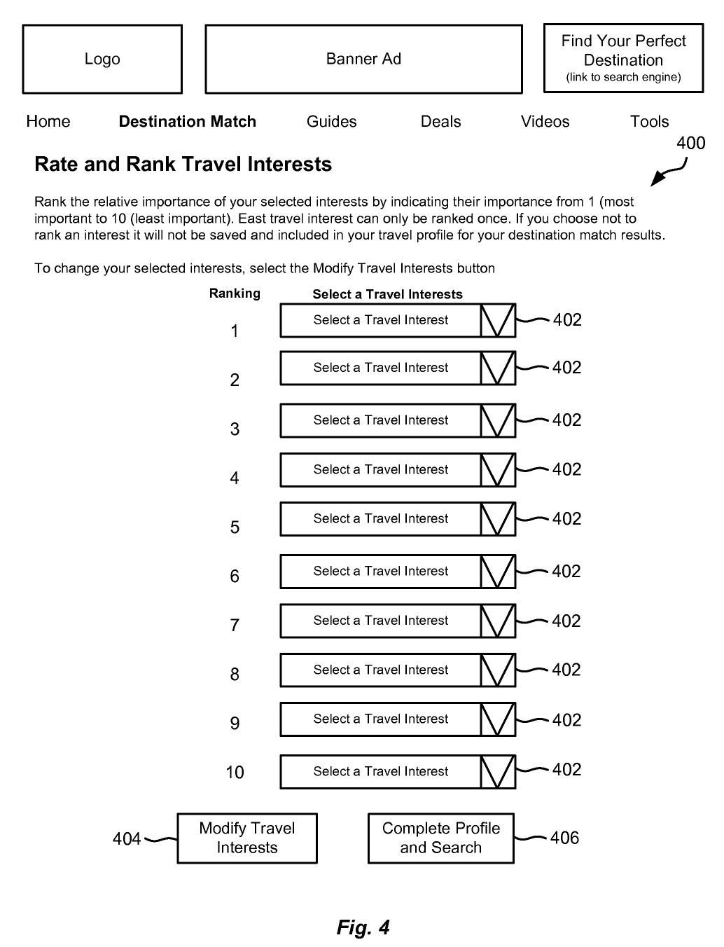

FIG. 4 shows an example of a page 400 that may be used to rank the selected attributes according to one embodiment. As shown, a pull-down menu 402 is provided for each ranking. When the user selects pull-down menu 402, the user is provided with the list of selected attributes that they had selected on the previous page 300 and 302. The user may then input the selected attribute for the appropriate rankings. For example, if the user wants to have scuba as the most important attribute, then the user would use pull-down menu 402 to put scuba in ranking #1. The user may continue to do so for all the selected attributes. Although ten attributes are shown and pull-down menus are provided, it will be understood that any number of rankings of attributes may be provided. Further, other ways of ranking the attributes may also be appreciated. For example, ratings for each of the attributes on a scale of 1-5 may be used.

A user may also modify travel attributes by selecting item 404 which brings the user back to page 300 where the user can select different attributes for ranking.

When the user selects complete profile in item 406, in step 208, destination matching engine 102 receives the ranking for the selected attributes.

In step 210, destination matching engine 102 may generate a travel profile for a user. The travel profile includes the rankings of travel attributes for the user. A travel profile may be generated for each user in the community of users. Destination matching engine 102 may then perform a search of the destination profiles to determine destination matching results.

### Destination Profile Creation

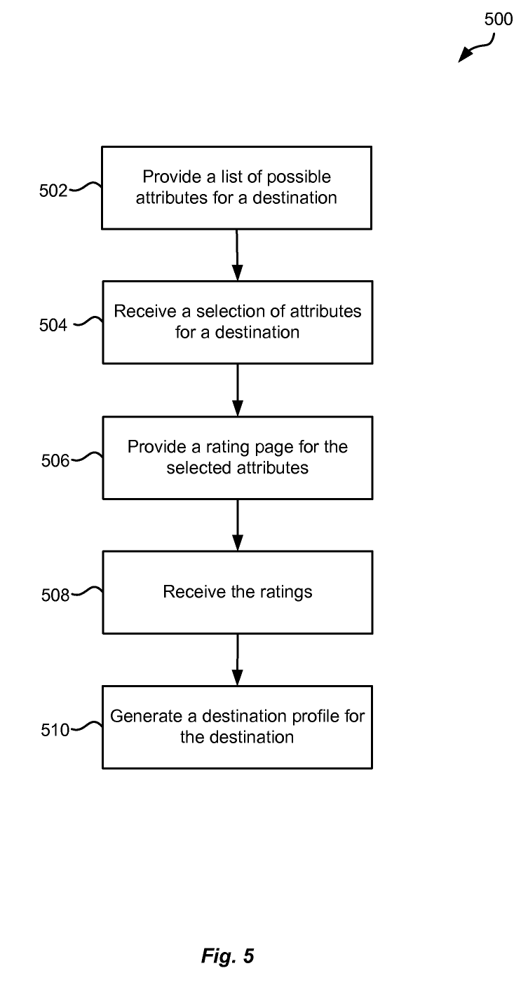

The destination profiles may be ratings for attributes for a field. For example, fields such as travel, financial services, health care, or other fields of interest, may include certain attributes and may be rated. The ratings may be input by an administrator or travel expert. FIG. 5 depicts an example of a flowchart 500 for inputting ratings to create destination profiles for destinations according to one embodiment. This process may be performed before searches are performed. Also, it should be noted that changes to the destination profiles may be ongoing as administrators or travel experts continually update the ratings for destinations.

In step 502, a list of possible attributes for a destination is provided. The list of possible attributes for a destination may be the same attributes, such as activities and categories of interests that may be been provided to users in FIGS. 3A and 3B. In this case, administrators or travel experts may select the attributes that a destination offers. This is different from the user selecting attributes that they are interested in. In this case, the administrator or travel expert has to determine what attributes the destination provides. For example, the administrator or travel expert may decide that Cozumel provides snorkeling, scuba, but not theme parks.

In step 504, destination profile generator 108 receives a selection of attributes for a destination. In step 506, destination profile generator 108 provides a rating page for the selected attributes. For example, an administrator or travel expert may now determine a rating for the attributes that a destination offers. This rating may indicate how well-known the attribute is at the destination. For example, Cozumel may be world-famous for scuba and thus should receive a rating of 5. However, Cozumel may not be well known for its theme parks and thus would receive a rating of 1 for that attribute.

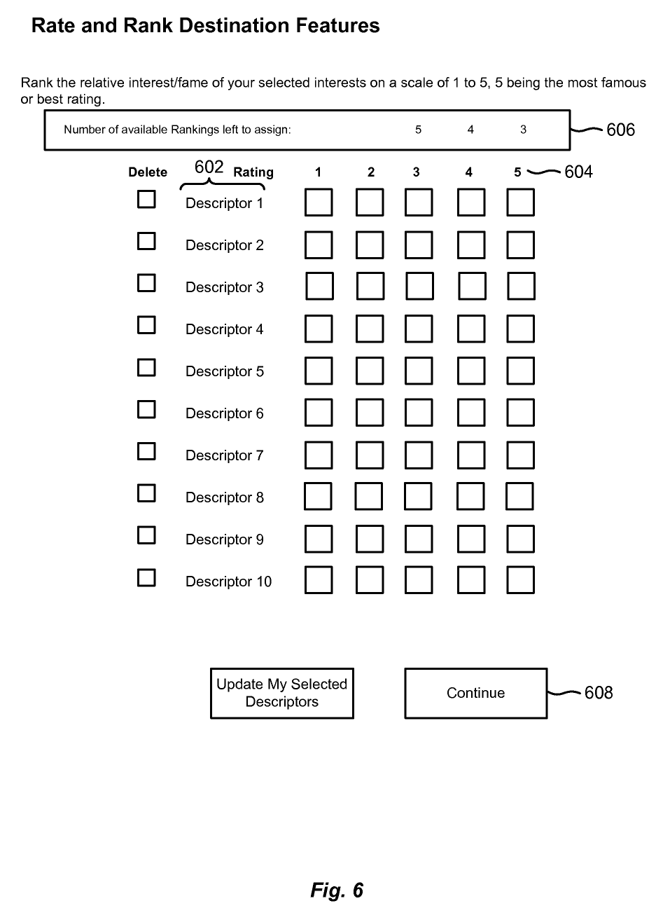

FIG. 6 shows an example of a rating page 600 according to one embodiment. As shown, a plurality of attributes 602 that were selected is provided. A rating system 604 allows an administrator or travel expert to rate each attribute 602. In one embodiment, a rating of 1 is the worst rating and a rating of 5 is the best rating. An administrator may be restricted to the number of ratings that he/she may assign. For example, as shown in area 606, the number of available rankings that can be assigned a “3” ranking 5, for a “4” ranking is 4 and for a “5” ranking is 3. Thus, for all the attributes 602 shown, only 3 rankings of 5 may be given. This prevents an administrator from over-ranking destinations as being the best. This provides objective rankings for destinations and also makes administrators be careful about declaring which destinations have world-famous attributes (the highest ranking of 5).

The administrator may then check boxes for each attribute 602 to associate a rating with the attribute. When the administrator is finished, he/she may select item 608 to submit the ratings.

When the ratings are submitted, in step 508, destination profile generator 108 receives the ratings. Additionally, other information may be received. For example, the administrator or travel expert may also input descriptive information for the destination. In one embodiment, activities for the destination, such as the top five must see/do or the bottom five over-rated may be provided in addition to other information, such as the best time to visit, background information on the destination, etc.

In step 510, destination profile generator 108 generates a destination profile for the destination. The destination profile includes the ratings that were submitted for the destination. A destination profile may be generated for each destination that may be searched.

### Destination Matching Results

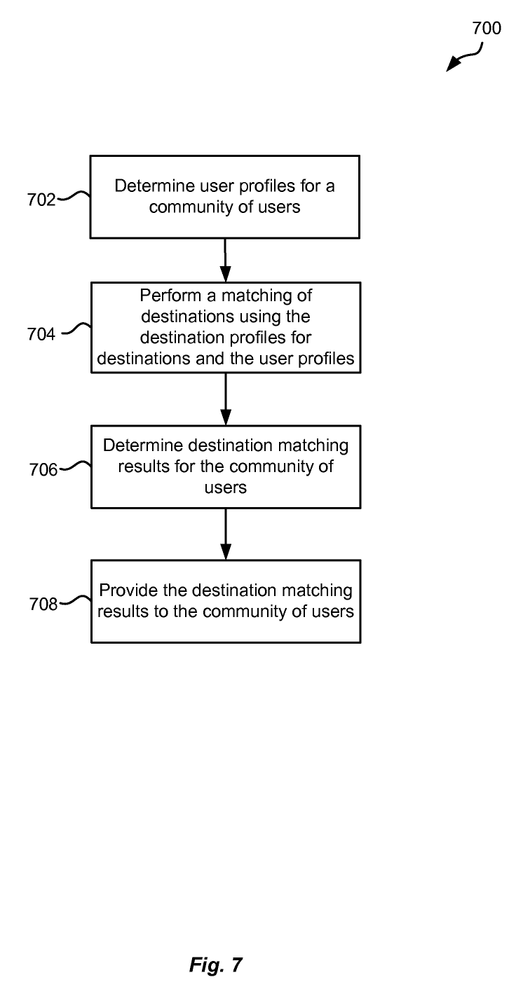

Once the travel profiles and destination profiles have been provided, users may use destination matching engine 102 to provide destination matching results. FIG. 7 depicts an example of a flowchart 700 for providing destination results. In step 702, destination matching engine 102 determines a merged profile for the community of users based upon the individual user profiles for that community of users. The community of users may be linked with other members somehow. For example, on a user may create a merged profile on a merged profile page, and may specify which users may be participating in a trip by “inviting” them to link their individual travel profiles to the group merged profile. The user may name the merged profile and the users in the invited community may receive an email invitation to join the merged profile as well as a notification the next time they access destination matching engine 102. Destination matching engine 102 then determines travel profiles for the merged profile of the group.

In step 704, destination matching engine 102 performs a matching of destinations using the destination profiles for destinations and the merged profile for the community of users. For example, the rankings of attributes in the merged profile and the ratings of attributes in the destination profiles may be used as dimensions in a search. For example, ratings for the user's top ten attributes are merged into destination matching engine 102.

The rankings inputted by the administrator or experts are then used as dimensions to determine destination matching results. The dimensions in the merged profile may then be applied to dimensions rated by experts for possible destinations to come up with a list of destinations. The destinations that have dimensions that best match the dimensions of the user profiles may then be determined. In one embodiment, the search first identifies all destinations that contain at least one attribute that the travel profile includes. Each destination is then assigned a “match weighting” for the profile by combining the ranking of the matched attribute at the destination with the relative ranked importance of that attribute to the travel profile. The more important a travel profile ranks an attribute, the more important the weighting a destination with that attribute rates. The higher the ranking of an attribute within a destination matched with a high importance level to the travel profile increases the match rating of the destination. For example, if a travel profile ranks scuba diving as a 3 and the merged profile includes scuba diving and ranks it 1, then that is a higher match weighting for the user than Monterey which includes scuba diving and ranks it as a 3.

In step 706, destination matching engine 102 determines destination matching results 106 for the community of users. In one embodiment, the matching results are provided for the community of users as a whole. That is, in one embodiment, search results are not provided for each user individually. Thus, the attributes of all of the users are taken into account to determine destination matching results 106 for the merged profile. The matching results may be tailored to the merged profile. For example, if a certain attribute was ranked as most important, it may be placed on the page in a prominent position. For example, deals on scuba diving may be placed at the top of the place if it is ranked high in the merged profile.

The matching results return a list of destinations. Thus, a user may rank attributes and be provided with destinations as results. A user does not need to know what destinations offer. Rather, the ranked attributes are used to filter through ratings provided by an expert to determine the list of destinations. Accordingly, just by knowing what most interests them, users may be provided with results that best match their interests using rating inputted by experts.

In step 708, destination matching engine 102 provides the destination matching results to the community of users. For example, destination matching engine 102 generates a web page that displays the search results. Each user may then use a user device 104 to access the web page. Although a web page is described, it will be understood that any notification of the destination matching results may be provided to users. For example, the results may be sent to users in an e-mail, posted in a newsgroup, etc. In one example, an email with a uniform resource locator (URL) for the web page with the destination search results may be sent to each user.

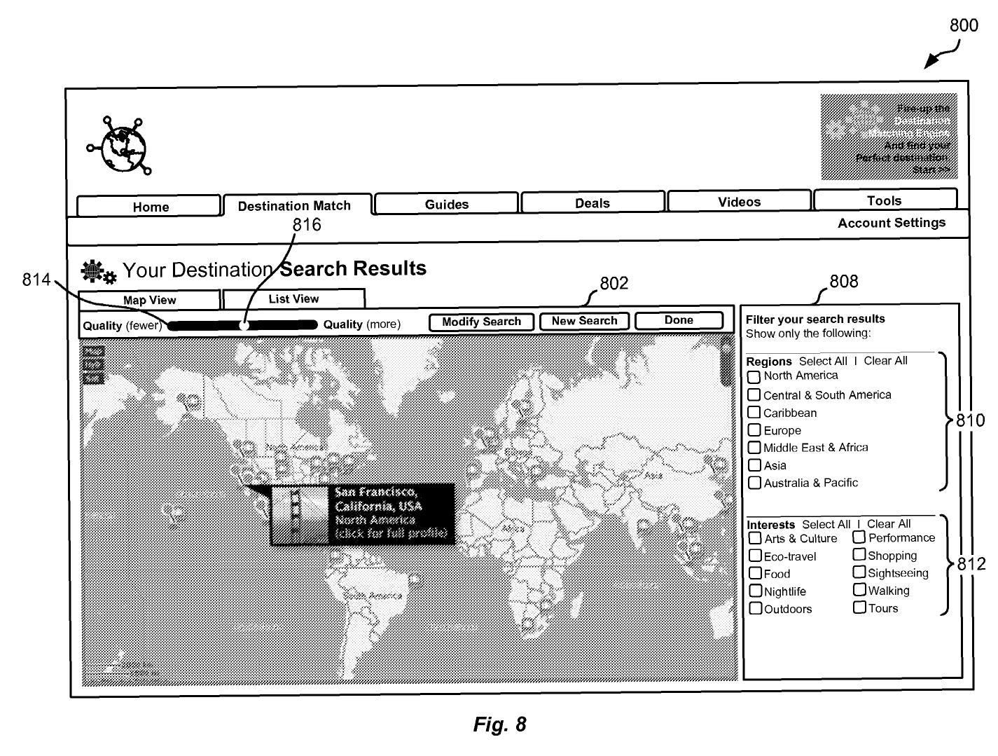

In one embodiment, the web page may include a map of destinations or a list of destinations. FIG. 8 depicts an example of a web page 800 that includes a map 802 according to one embodiment. As shown, pins 804 may be provided for destinations that were determined in destination matching results 106. A user may move a pointer (e.g., a mouse pointer) over a destination to receive additional information 806. For example, a pointer is moved over pin 804-1 and information for San Francisco, Calif. is provided. The user may then select additional information 806 or pin 804 to be provided with a full profile on the location, which will be described in more detail below.

A filter 808 may also be provided to allow a user to filter attributes. In section 810, a user may filter the map to only show various regions. For example, if a user only wanted to see destinations in Asia, the user would select the item by Asia. The map may be redrawn with an expanded view of just Asia.

Also, in a section 812, user may select attributes that are required for the destinations. For example, these are attributes that a destination must have. That is, the travel profile for a destination should have the attribute selected as being offered by the destination and also rated. Because the destinations are matched based on an “or” search (rather than an “and) search, it is possible that some destinations may not have the attributes that a user is most interested in. Accordingly, users can use area 812 to filter out some destinations. For example, if nightlife is a required attribute, upon selecting the nightlife item, only destinations that include the attribute nightlife may be shown on map 802. This allows a user to quickly filter destinations that include attributes that the user wants.

A slider 814 is also provided. The slider allows the user to specify how many destinations are shown on map 802. For example, if an item 816 is slid to the left, only destinations that provide the most relevant matches are shown on map 802. Thus, destinations that are less relevant are removed. Also, if a user wants to see more destinations that may have been rated as less relevant, the user may slide item 816 to the right. This provides an easy way for a user to show more or fewer destinations.

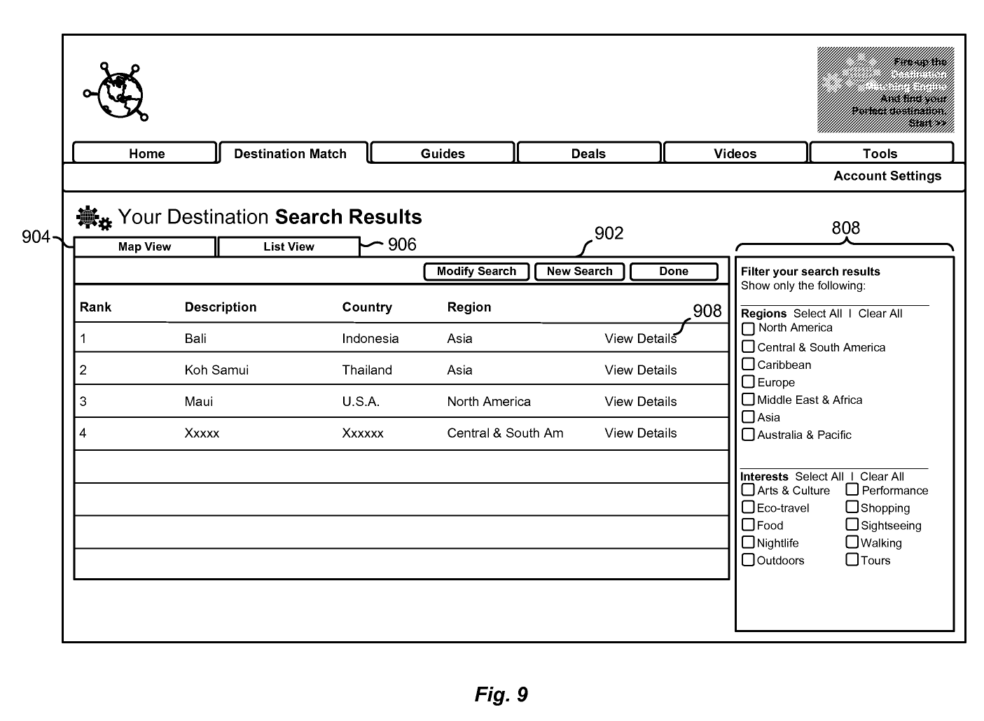

In addition to the map, FIG. 9 shows an example of a list of destinations 902 according to one embodiment. As shown, a user may toggle from a map view 904 to a list view 906. Map view 904 shows the map provided in FIG. 8 and list view 906 shows the list shown in FIG. 9. The list shows each destination found in the matching results. The user then sees a ranking by the destination that was determined. For example, Bali ranks as the #1 destination based on the travel profiles for the community of users. Users may also select a view details item 908 to view more details for each destination. Also, the same filtering 808 is provided for the list of destinations 902.

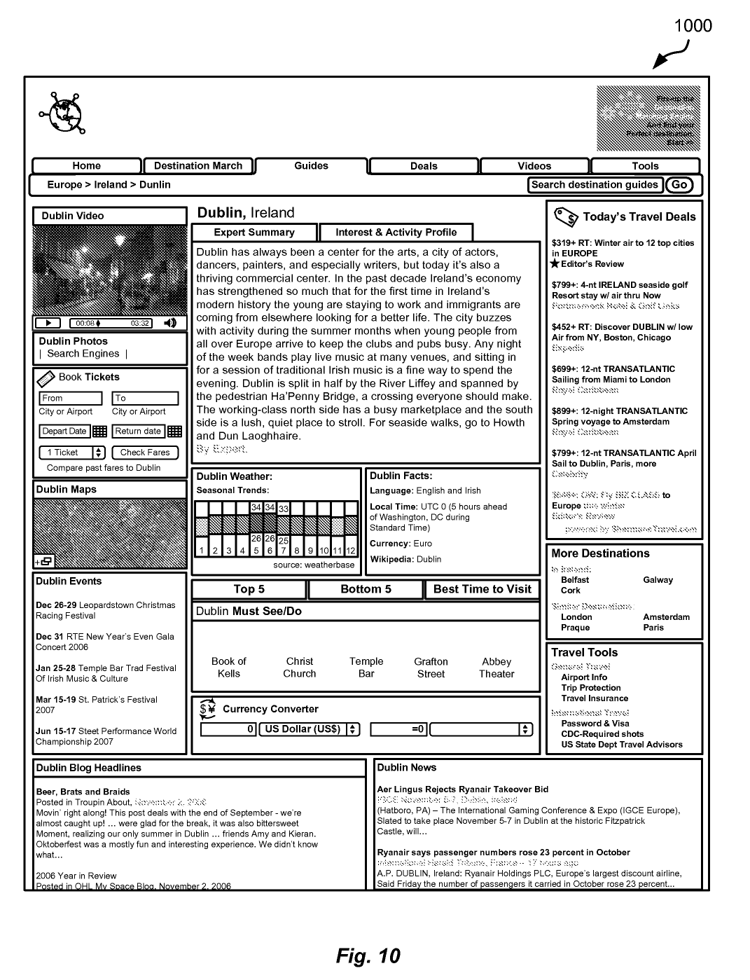

As mentioned above, a page may be provided that includes more information for a destination. This page may aggregate relevant information that a user might need in planning a trip. FIG. 10 shows a page 1000 displaying more details for a destination according to one embodiment. For example, more details for the destination of Dublin are provided. The details include travel deals, weather, background information, facts, events, etc.

Page 1000 aggregates information from other websites into a single site. Thus, users do not have to individually search for all the information. Rather, users may come to destination page 1000 to find information for a destination. The information may have been input by an administrator or may be links to other sites that allow the user to navigate to the other sites if interested. This alleviates individual searches and provides a base that a user can always look at to find relevant information for a destination. For example, the results may include links to the best deals that match the user's specified budget and “lifestyle” parameters.

### Changes to Destination Matching Results

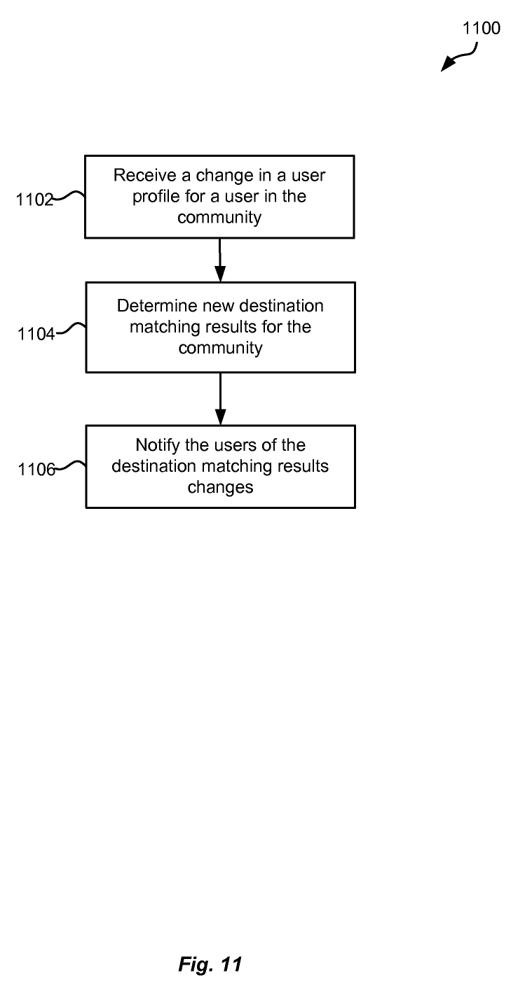

While looking at the destination matching results 104, users may decide to change their travel profile. For example, different attributes may be input and ranked. This may cause a change to destination matching results 106. FIG. 11 shows an example of a simplified flowchart 1100 for providing new destination matching results 106.

In step 1102, destination matching engine 102 receives a change in a user profile for a user in the community. For example, the user may edit the attributes or change the rankings for attributes.

In step 1104, new destination matching results for the community are determined. For example, new destinations may be included in the results or the destinations may be ranked differently. For example, destination matching engine 102 generates a new destination mapping results page. Because the user may make multiple iterations to their travel profile before finalizing their changes, the user may select a “Save this Merged Profile with New Individual Rankings button” for a new version of the merged destination results to be saved and shared with other members of the community.

In step 1106, destination matching engine 102 notifies the users of the destination matching results changes. For examples, users may be e-mailed to notify them that the destination matching results 106 have been changed. The e-mail may include a URL to a new web page that includes the new results. Users may also be notified through a system message when they access the matching engine.

Accordingly, destination matching engine 102 provides coordination among the community of users. Users may enter travel profiles separately and they may be saved by destination matching engine 102. When searches are performed by a user, user profiles for other users are determined and destination matching results are determined for the community. Destination matching engine 102 also provides results to all users in the community. Users can then review the destinations on their own to determine which destinations they are interested in. Further, users may make changes to their travel profile and destination matching engine 102 may change the destination results. The changes to the destination matching results 106 are sent to each user in the community when changes happen and are saved. Individual users may log in to view the destination matching results at any time. Other tools may also be provided that allows users to indicate which destinations in destination matching results are of the most interest to them. Thus, users may communicate with other users to tell them which destinations they would like to go to in the trip. Thus, system 100 provides a tool that allows a community of users to coordinate and plan a trip easily.

Although the description has been described with respect to particular embodiments thereof, these particular embodiments are merely illustrative, and not restrictive. Although travel is discussed, destination matching engine 102 may be used for activities other than travel. For example, particular embodiments may be used in financial services (experts provide standardized ratings on many variables of various investment alternatives, mutual funds, etc.), enabling consumers to screen their preferences against a large database. Similarly, health services could work with medical experts taking symptoms and presentations and referencing them against probably diagnosis and outcomes.

Accordingly, any field in which attributes can be quantified for categories may be used. These attributes may be rated by experts in the field for each category. As such, different categories in the field may have different ratings. Then, users can input their rankings of attributes and be provided with a list of categories that include attributes that best match their rankings. Using the financial services as an example, the categories may be different stocks, mutual funds, or other investment ideas. The attributes may be characteristics for the investment ideas, such as growth, aggressive, etc. Financial experts may rate the attributes for each investment idea. Then, users can rank the attributes they desire and be provided with investment ideas that include attributes that best match their ranked attributes.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that which is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated particular embodiments, including what is described in the Abstract, is not intended to be exhaustive or to limit the invention to the precise forms disclosed herein. While specific particular embodiments of, and examples for, the invention are described herein for illustrative purposes only, various equivalent modifications are possible within the spirit and scope, as those skilled in the relevant art will recognize and appreciate. As indicated, these modifications may be made to the present invention in light of the foregoing description of illustrated particular embodiments and are to be included within the spirit and scope.

Thus, while the present invention has been described herein with reference to particular embodiments thereof, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. It is intended that the invention not be limited to the particular terms used in following claims and/or to the particular embodiment disclosed as the best mode contemplated for carrying out this invention, but that the invention will include any and all particular embodiments and equivalents falling within the scope of the appended claims.

We claim:

1. A method comprising:
determining one or more travel profiles from one or more users, wherein the one or more travel profiles include rankings for attributes;
determining a plurality of destination profiles for a plurality of destinations, each destination profile including ratings for one or more attributes associated with the destination profile, the ratings for a destination being input by one or more users considered an expert for the destination;
determining destination matching results of one or more destinations based on the rankings in the one or more travel profiles and the ratings for the one or more attributes associated with the plurality of destination profiles; and
providing the destination matching results for access by the one or more users.

2. The method of claim 1, further comprising:
receiving a plurality of travel profiles from a community of users; and
determining a merged profile for the plurality of travel profiles, the merged profile being generated based on the rankings of one or more attributes for the plurality of travel profiles.

3. The method of claim 1, wherein the destinations in the destination matching results represent destinations that are determined to best match the travel profiles for the community taken together.

4. The method of claim 1, further comprising:
receiving a change in a travel profile from a user in the community of users;
determining a new destination matching result based on the change in the travel profile; and
providing the new destination matching result for access by the community of users.

5. The method of claim 1, further comprising providing a map in an interface, the map including a plurality of graphical representations where destinations in the destination matching results are located.

6. The method of claim 5, further comprising providing a slider that increases or decreases a number of the plurality of graphical representations shown on the map.

7. The method of claim 1, further comprising:
providing a list of attributes to a user in the one or more users;
receiving a selection of attributes in the list of attributes;
receiving a ranking of the selected attributes; and
generating the travel profile using the ranking.

8. The method of claim 7, wherein determining a search result comprises using the ranking of the selected attributes from each user in the one or more users to determine the search result of destinations, wherein users in the one or more users can select different attributes and rank the attributes differently.

9. The method of claim 1, further comprising:
receiving a list of attributes that are associated with a destination;
receiving an expert rating of attributes for a plurality of possible destinations from the one or more users considered to be an expert for the plurality of possible destinations; and
determining the search result of destinations based on the expert rating of attributes and the rankings of attributes received from the one or more users.

10. The method of claim 1, further comprising:
receiving filter criteria for the destination matching results; and
filtering the destination matching results to include a subset of destinations based on the filter criteria, wherein the filter criteria indicate one or more attributes that a destination must have, wherein the filtered destination matching results only include destinations that are associated with the one or more attributes.

11. Software encoded in one or more tangible media for execution by the one or more processors and when executed operable to:
determine one or more travel profiles from one or more users, wherein the one or more travel profiles include rankings for attributes;
determine a plurality of destination profiles for a plurality of destinations, each destination profile including ratings for one or more attributes associated with the destination profile, the ratings for a destination being input by one or more users considered an expert for the destination;
determine destination matching results of one or more destinations based on the rankings in the one or more travel profiles and the ratings for the one or more attributes associated with the plurality of destination profiles; and
provide the destination matching results for access by the one or more users.

12. The software of claim 11, wherein the software, when executed, is further operable to:
receive a plurality of travel profiles from a community of users; and
determine a merged profile for the plurality of travel profiles, the merged profile being generated based on the rankings of one or more attributes for the plurality of travel profiles.

13. The software of claim 11, wherein the destinations in the destination matching results represent destinations that are determined to best match the travel profiles for the community taken together.

14. The software of claim 1, wherein the software, when executed, is further operable to:
receive a change in a travel profile from a user in the community of users;
determine a new destination matching result based on the change in the travel profile; and
provide the new destination matching result for access by the community of users.

15. The software of claim 1, wherein the software, when executed, is further operable to provide a map in an interface, the map including a plurality of graphical representations where destinations in the destination matching results are located.

16. The software of claim 15, further comprising providing a slider that increases or decreases a number of the plurality of graphical representations shown on the map.

17. The software of claim 1, wherein the software, when executed, is further operable to:
provide a list of attributes to a user in the one or more users;
receive a selection of attributes in the list of attributes;
receive a ranking of the selected attributes; and
generate the travel profile using the ranking.

18. The software of claim 6, wherein the software, when executed, is further operable to use the ranking of the selected attributes from each user in the one or more users to determine the search result of destinations, wherein users in the one or more users can select different attributes and rank the attributes differently.

19. The software of claim 1, wherein the software, when executed, is further operable to:
receive a list of attributes that are associated with a destination;
receive an expert rating of attributes for a plurality of possible destinations from the one or more users considered to be an expert for the plurality of possible destinations; and
determine the search result of destinations based on the expert rating of attributes and the rankings of attributes received from the one or more users.

20. The software of claim 1, wherein the software, when executed, is further operable to:
receive filter criteria for the destination matching results; and
filter the destination matching results to include a subset of destinations based on the filter criteria, wherein the filter criteria indicate one or more attributes that a destination must have, wherein the filtered destination matching results only include destinations that are associated with the one or more attributes.
